(19) United States
(12) Patent Application Publication
(10) Pub. No.: US 2001/0008237 A1
(43) Pub. Date: Jul. 19, 2001

(54) Control for an electrical appliance, particularly an electrical cooking appliance

(76) Inventor: Willy Essig, Boeblingen (DE)

Correspondence Address: Akerman, Senterfitt & Eidson, P.A., Esperante Building, Suite 400, 222 Lakeview Avenue, Post Office Box 3188, West Palm Beach, FL, 33402-3188, US

(21) Appl. No.: 09/733,340

(22) Filed: Dec. 8, 2000

(30) Foreign Application Priority Data
Dec. 8, 1999 (DE) 199 59 224.1

(51) Int. Cl. H05B 1/02; H05B 3/68

(52) U.S. Cl. 219/482; 219/497; 219/460.1

(57) ABSTRACT

A control is provided for an electrical appliance having at least one electrical operating device associated with a working area, particularly for an electrical cooking appliance with a heating element and a glass ceramic area as the working area. The control has a power unit for supplying the operating device with electric power, as well as a control unit adapted to the power unit for controlling the latter. The control unit is housed in an operating unit, separate from the electrical appliance and which comprises operating elements and display devices for displaying the operating states of the electrical appliance or the control. For the control-effective connection between the control and power units, there is a coupling device positioned laterally alongside the glass ceramic cooking area and which permits a fitting of the operating unit outside the glass ceramic cooking area in a docking position, where the control unit and power unit are power-effectively connected. The invention combines a high degree of operating comfort and operational safety of the control with optimum freedom when using the complete working area.

### BACKGROUND OF THE INVENTION

1. Field of the Invention

The invention relates to a control for an electrical appliance, which has at least one electrical operating device associated with a working area of the electrical appliance, more particularly a control for an electrical cooking appliance with a glass ceramic area as the working area.

2. Description of the Prior Art

In a preferred field of application of the invention, namely the control of electrically operated domestic appliances, particularly electric cookers with a glass ceramic cooking area and/or an electric baking oven, the operating devices to be controlled e.g. comprise radiant heaters, heating resistors, etc. The associated controls generally have a multistage operating procedure and generally have at least one power unit matched to the nature of the electrical operating device for supplying the latter with electric power and at least one control unit control-effectively connected to the power unit for controlling the latter. In modern electrical cooking appliances with a glass ceramic cooking area said two operating units are jointly housed below the glass ceramic plate in the interior of the hob. The operating elements associated with the control for the operation of the latter by a user are fitted to the outside of the electrical appliance.

A known and very frequently used construction for the operating elements consists of knobs, which are generally arranged in single form or combined into groups on a front panel of the electrical appliance below the standard working level. As a result of this arrangement the scales of said knobs are sometimes difficult to read, which can impair the precision of operation. There is also a risk of the operating elements being reached and incorrectly operated by small children. It is also difficult to keep them clean. These problems could in part be eliminated by placing the operating elements on the top of the appliance. In exemplified manner in this connection, EP 797 227 describes a particularly advantageous construction with operating elements in the form of knobs which can be placed on a glass ceramic plate and which can be magnetically retained through the plate by means of holding magnets located on the underside of the glass ceramic plate. Since, for reliable handling purposes, the knobs must have a certain overall height, they can be prejudicial to the handling of cooking appliances on the working surface. Operating elements in the form of contact switches are also known and are placed in a specially marked control panel in the vicinity of and on the glass ceramic plate. Such operating devices also known as touch controls can be problematical if there is not an adequate spacing from the heatable cooking zones, because there is a risk of burns on attempting to use them. In addition, the operating area on the glass ceramic plate limits the usable size of the working area.

Another operating concept is e.g. disclosed by German utility model 296 22 066, which relates to an electrically operated domestic appliance, in which the operating elements and display elements are housed in a separate remote control device and there is a wireless transmission of information from the remote control to the domestic appliance and vice versa. As a result of this remote control the appliance operator is no longer forced to stand in the immediate vicinity of the domestic appliance in order to operate and monitor the latter. The possibility of remote control from random locations may lead the appliance operator not to directly observe the cooking process. This can lead to inadequate cooking results and is also problematical for safety reasons, if it is firstly necessary to seek the remote control which has been set aside somewhere e.g. in the case of a cooking product boiling over.

Conventional solutions for control are also not of an optimum nature with respect to the aim of offering the user a wide choice of appliances with respect to the equipment, operating scope, design, operating procedure, etc. The equipment, operating scope and operating possibilities of the electrical appliance are largely fixed when the combination of the control unit and power unit in the form of a subassembly is installed. This means that in the early development stages the individual components of the electrical appliance must be matched to one another in such a way that the desired appliance characteristics are available. As a result, particularly for cost reasons, only a small number of appliance variants can be offered for sale.

### SUMMARY OF THE INVENTION

The object of the invention is to avoid the disadvantages of this prior art. The aim is in particular to provide a control for an electrical appliance, which on the one hand permits a safe and reliable operation of the appliance and on the other in cost-effective manner assists in providing a multiplicity of appliances adapted to the wishes of the consumer.

This problem is solved by a control for controlling an electrical appliance, the electrical appliance comprising a working area and at least one electrical operating device associated with the working area, the control comprising; at least one power unit for supplying electric power to the operating device; at least one control unit for controlling the power unit; the control unit being associated with a seperate operating unit for operating the control; and at least one docking device for coupling the control unit to the power unit in a control-effective manner; wherein the docking device is constructed in such a way that the operating unit is located in a docking position outside the working area. Preferred further developments are given in the dependent claims. By reference the wording of all the claims is made into the content of the present description.

In the case of a control according to the invention the control unit is associated with a separate operating unit for operating the control. The separate control unit can essentially contain the entire control and regulating parts for the electrical appliance by means of which the at least one power unit is controlled. In this case it can be adequate if the electrical appliance only contains sensors or the like which supply measurable and controlled variables. Thus, there is a spatial separation of the control into a power switching part located in the electrical appliance and a control and regulating part located in the separate control unit associated with the operating unit. A major advantage of this separation is the possibility created of simple upgrading, downgrading or conversion of the electrical appliance in order to adapt it to the needs of the user. With such an adaptation there is no need to intervene in the “hardware” of the control. Thus, e.g. by the replacement of a control or operating unit a function not initially considered important by the user, such as e.g. an automatic time switch or the like can easily be subsequently fitted. This possibility of upgrading or conversion can be useful if there is a change of ownership of the electrical appliance and as a result the changes of selling said appliance are increased, because a new owner only has to acquire an operating unit corresponding to her needs in order to adapt said appliance in optimum manner thereto.

The operating unit, which can also be called an operating module, can be formed by a separate subassembly, which can be removed from or fitted to the electrical appliance in simple manner and in particular without tools. The operating unit preferably has at least one input device for inputting control instructions for the control, i.e. one or more suitable operating elements such as knobs, sliders, keys, etc. For the control-effective coupling of the control unit to the power unit there is at least one coupling device constructed in such a way that the operating unit is located outside the working area of the electrical appliance in a coupling position in which the control unit is control-effectively connected to the power unit. As a result of the coupling device, which is referred to here as a docking device or station, the geometrically correct location for the control-effective fitting of the operating unit in the immediate vicinity of the working area is predetermined. The control is appropriately designed in such a way that the control-effective connection between control unit and power unit only takes place when the operating unit is in the coupling or docking position. This measure, which is particularly advantageous for safety reasons, can be technically implemented in different alternative or cumulatively provided manners. It is in particular possible to design the power supply for the control unit and/or power unit in such a way that it is only active if the operating unit is in the docking position. Alternatively or additionally the data traffic necessary for a control-effective connection between control and power units is only made possible if the operating part is in the docking position. Advantageous implementation possibilities are explained hereinafter.

The invention finally provides for the operating unit to be located outside the working area of the electrical appliance, but preferably in the immediate vicinity thereof, in the described docking position. This ensures that working with the electrical appliance is not hindered by the components necessary for its operation. In the case of electrical appliances with a glass ceramic area as the working area, the situation can be such that the entire glass ceramic area can be used, e.g. for moving a saucepan out of the vicinity of a cooking zone into an unheated marginal region of the cooking area. It is also possible to use the entire glass ceramic area for the provision of cooking zones, which can be more favourably dimensioned and/or positioned compared with conventional cooking zones.

Within the scope of the invention various advantageous modes of design and/or arrangement of the docking device are possible. In particular, the docking device can be provided on a docking unit separate from the electrical appliance and which can be fitted to the latter outside its working area. A major advantage of this variant is the possibility of subsequent upgrading, downgrading or conversion of the electrical appliance in order to adapt the latter to the special requirements of its installation environment and/or to the individual needs of the user.

The docking unit is preferably constructed in such a way that it can be integrated into a frame surrounding the working area of the electrical appliance. The resulting possible arrangement of an operating area in the immediate vicinity of the working area creates optimum working conditions. For example, the docking unit can be fitted into a frame gap already constructionally provided or subsequently fitted on the electrical appliance. The fitted docking unit can then e.g. project laterally over the original frame contour. In the case of electrical appliances with a glass ceramic working area it is possible to create a lateral frame extension substantially level with the working surface. As a special adaptation for built-in appliances, in which e.g. the glass ceramic area is fitted into a recess of a work plate, the docking unit can be constructed so flat that on the one hand it can be fitted above the work plate and preferably rests thereon and on the other does not or does not significantly project over and beyond the work level defined by the glass ceramic top.

It is also possible to integrate the docking device into a frame of the electrical appliance, particularly in the form of an outwardly projecting frame extension, which e.g. in the vicinity of the appliance top projects laterally over the base contour of the appliance. It is possible to design the operating unit in such a way that it can be coupled to or detached from the docking device without the aid of tools. In this case a control-effective connection between operating part and power unit exists if the operating part is docked and operation is impossible if the operating part is removed. The situation can be such that the docking device is so constructed e.g. with the aid of mechanical and/or magnetic holding and guiding devices that the operating part can only be fitted in the docking position.

It is alternatively or additionally also possible for the docking device to have a guide device or bearing device for the movable mounting of the operating part on the docking device and which is constructed in such a way that the operating part is movable with the aid of the guide device in a controlled manner between a rest or off position (without control-effective connection to the power unit) and the docking position, e.g. by pivoting and/or linear displacement. Therefore the operating part can remain at a clearly defined location on the electrical appliance, even if no operation is required or desired. In particular the area of the docking device can be designed in such a way that operating elements present on the operating part in the rest position are not operable and/or are inaccessible, in particular by covering them.

The mobility of the operating part between the rest position and the docking position is made possible in a further development through the operating part being connected or connectable in pivotable manner to the docking device. A preferred form of a uniaxial swivel hinge or joint with hinge or joint elements, which are magnetically retained on one another, will be explained in conjunction with preferred embodiments. The magnetic mounting of cooperating guide or bearing elements of a swivel joint or a linear guide device on the docking device and operating part makes possible an advantageous combination of the guided movement between the rest position and the docking position on the one hand and a tool-free detachability of the operating part from the docking device on the other.

For supplying with electric power the operating unit can have its own power supply source, e.g. a rechargeable power storage device such as a battery. Preference is given to operating units without their own power supply for the control functions. This inter alia leads to the advantage that such operating parts can be manufactured less expensively, more compactly and lighter than corresponding operating parts with a battery or the like.

Preference is given to a power supply with which the operating part can be detachably connected, such a connection preferably assuming a specific spatial association of the operating part with the electrical appliance. The situation can in particular be such that the power supply is so constructed that the control unit is substantially only supplied or suppliable with electric power when the operating part is in the docking position. This makes operation particularly safe, because there must be a deliberate positioning of the operating part in the docking position.

A safety device ensuring that the operating part or control unit can only function when the operating part is in the docking position can e.g. comprise a mechanically or contactless, e.g. magnetically operable switch, which is operated when the operating part is fitted in the docking position and is otherwise released. It is also possible to provide in the vicinity of the docking device electric contacts for the connection of the mechanism to be supplied in the operating part to the power supply of the electrical appliance. A preferred embodiment avoiding such bare electric contacts is characterized in that the power supply comprises at least one receiving coil associated with the operating part or the control unit and at least one transmitting coil associated with the area of the docking device of an inductive power transmission means. This allows a contactless and line-unconnected power supply of the operating part. Moreover, by a suitable arrangement of the transmitting and receiving coils, it is ensured that only in a specific, predetermined position, i.e. the docking position, is the receiving coil in the active or working area of the transmitting coil and consequently a power transmission takes place.

To ensure the exchange of control-relevant data or signals between the control unit and the power unit, it is possible to provide suitable electric lines, optionally with suitable electric contacts between said operating units. In preferred embodiments the control has a signal transmission means, preferably operating by infrared radiation, for the wireless transmission of signals between the control unit and the power unit. A signal transmission by other electromagnetic or sound waves is also possible. The signal transmission means preferably operates bidirectionally. This makes it possible on the one hand to transmit control signals from the control unit to the power unit and on the other of signals characterizing operating parameters of the electrical appliance and/or the control from the power unit to the control unit. The signal transmission means is preferably constructed in such a way that signal transmission is only possible if the operating part is in the docking position. This can e.g. be achieved by suitable arrangement of transmission devices in the vicinity of the docking device on the one hand and on the operating part on the other.

Preferably on the operating part there is at least one preferably electrical display device for a preferably optical display of at least one operating parameter characterizing the operating state of the control and/or the electrical appliance or a quantity characterizing said operating state. Such display devices can e.g. be simple illuminated displays, particularly light-emitting diodes and/or alphanumeric displays. The display devices are preferably unmistakably associated with the corresponding operating elements acting on the displayed operating parameters. A particularly user-friendly, easily readable and comprehensible display is brought about in a preferred embodiment in that the operating part has an operating element for setting at least one control parameter and into which is integrated an electrical display device for a preferably optical display of the set control parameter or an operating parameter influenced as a result of the control parameter. This permits an unmistakable association between the operation by the user and the setting or change on the electrical appliance brought about by the operating process. A display device can in particular incorporate a liquid crystal display, which provides particularly informative optical signals. Preferences given to twelve segment circular displays integrated into knobs and these will be explained in the embodiments.

It is possible to use an operating module of the described type for the central control of a complete appliance family, such as e.g. a cooking area, baking oven, vapour exhaust hood, microwave, etc. In this case on each of said individual appliances through a corresponding docking device an equivalent location can be provided for the coupling of the operating unit. For rationalizing manufacturing processes a few basic models of electrical cooking appliances can be constructed in standardized form and in particular the power units can be identically constructed for a plurality of different appliances. By means of differently equipped operating modules it is possible in this way to inexpensively provide electrical appliances differing as regards quality and/or equipment and/or operating scope.

It is also possible to leave on the electrical appliance certain switching or display functions, e.g. a general on/off switch, hot indicators to warn against contact with hot cooking zones, etc.

The invention also relates to an electrical appliance, more particularly controllable with an above-described control, which contains at least one power unit and which is substantially free from operating elements and/or control and regulating parts. It can be equipped with a docking device of the aforementioned type or can be suitable for equipping with a separate docking unit and can optionally be specially prepared for this, e.g. by a removable frame part keeping free an installation location for a docking device. The invention also covers all operating parts of the described type suitable for or particularly adapted to cooperating with docking devices according to the invention. The invention also covers a docking device provided in a docking unit separate from an electrical appliance and as a result of whose fitting the electrical appliance can be upgraded or converted to an electrical appliance of the described type.

These and further features can be gathered from the claims, description and drawings and the individual features, either singly or in the form of subcombinations, can be implemented in an embodiment of the invention and in other fields and can represent advantageous constructions. Embodiments of the invention are explained hereinafter relative to the attached drawings, wherein show:

### BRIEF DESCRIPTION OF THE INVENTION

FIG. 1 A plan view of the area of a frame of a glass ceramic hob built into a work plate with a separate docking device and associated operating unit integrated into the hob frame.

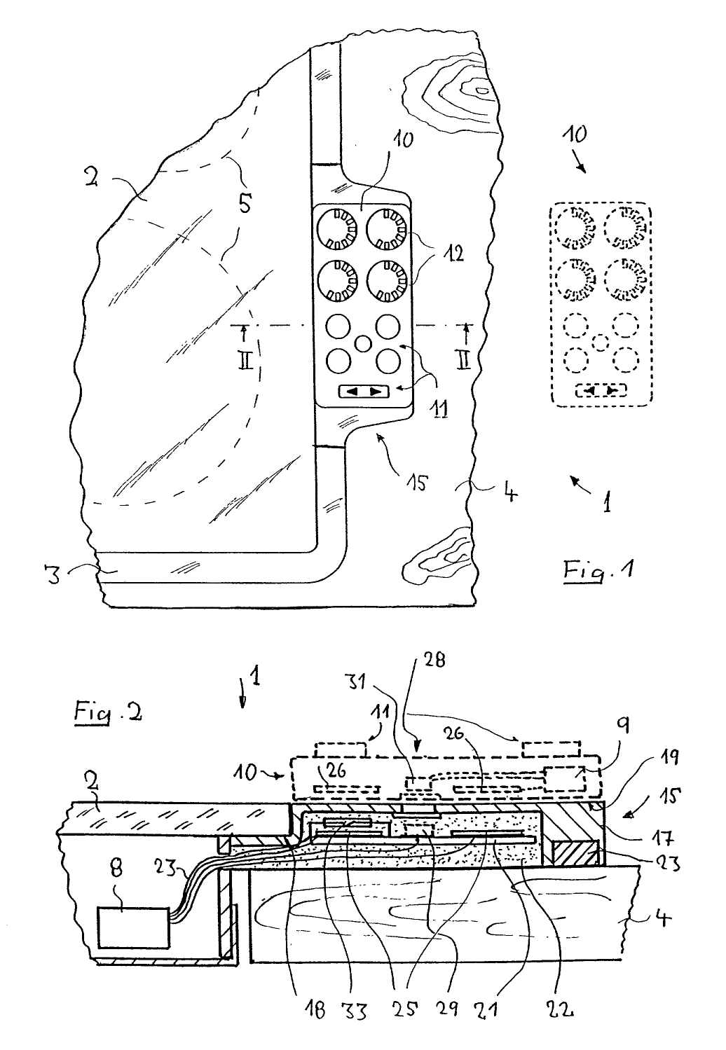

FIG. 2 A vertical section along line II-II in FIG. 1 for explaining the installation of the separate docking unit on the marginal region of the glass ceramic area.

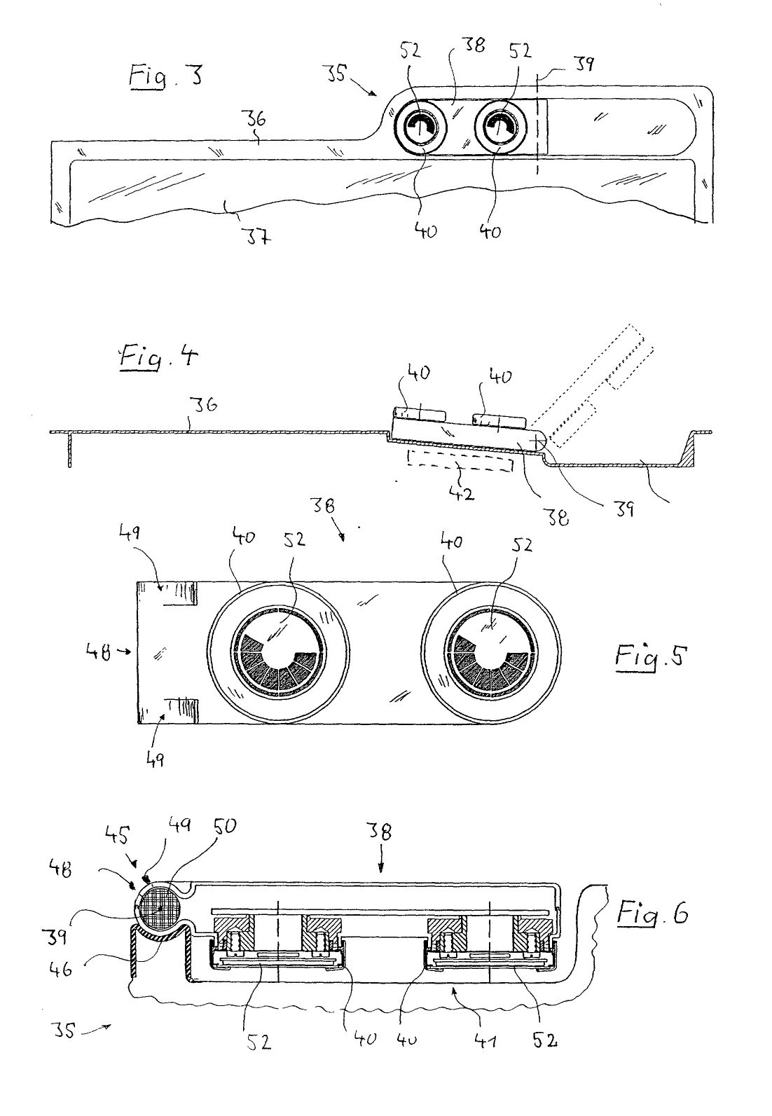

FIG. 3 A plan view on the frame of a built-in hob surrounding a glass ceramic plate and with a docking device integrated into the frame and an operating part pivotably mounted on the docking device.

FIG. 4 A vertical section through the frame with docking device in FIG. 3 for illustrating the pivoting movement of the operating part between the docking position illustrated by continuous lines and the rest position with concealed operating elements.

FIG. 5 A plan view of the operating part according to FIGS. 3 and 4 for illustrating the rotary operating elements with integrated twelve segment LCD display means.

FIG. 6 A vertical section through an operating module according to FIGS. 3 to 5, which is detachably fixed to a docking device by means of a uniaxial swivel joint with joint elements magnetically held on one another and which is in the rest position with concealed operating elements.

FIG. 7 A diagrammatic plan view of another embodiment with an operating part movable by linear displacement between a left-hand docking position and a right-hand rest position.

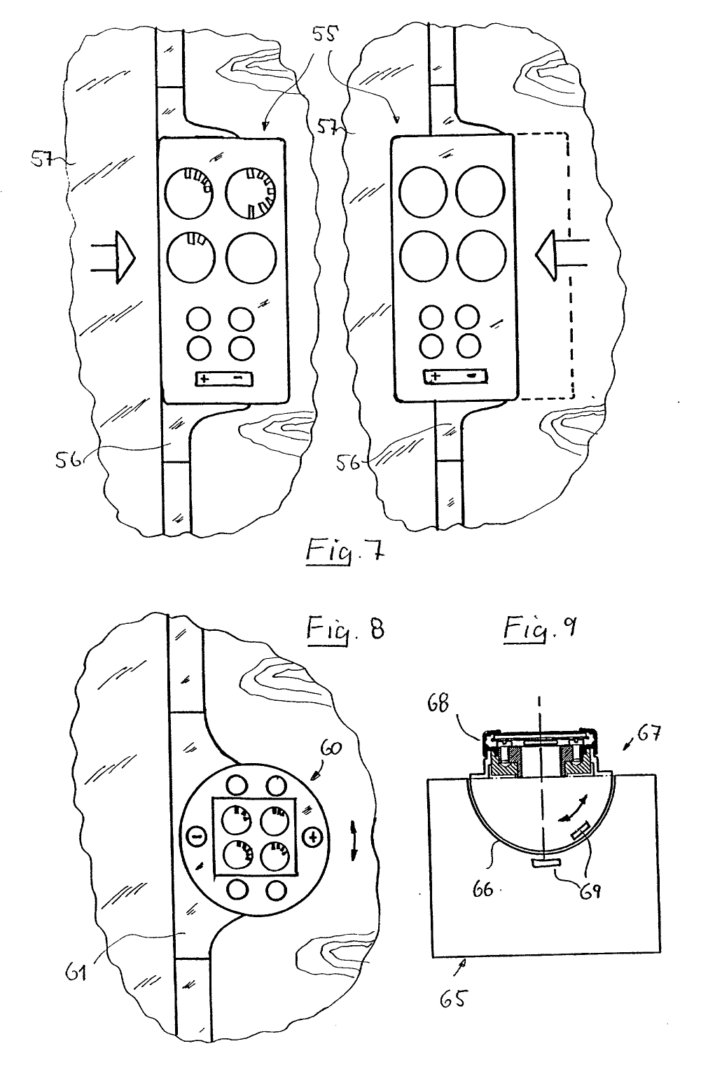

FIG. 8 A diagrammatic plan view of an embodiment of an operating part, rotatable by rotating about a vertical axis between the rest position and the docking position.

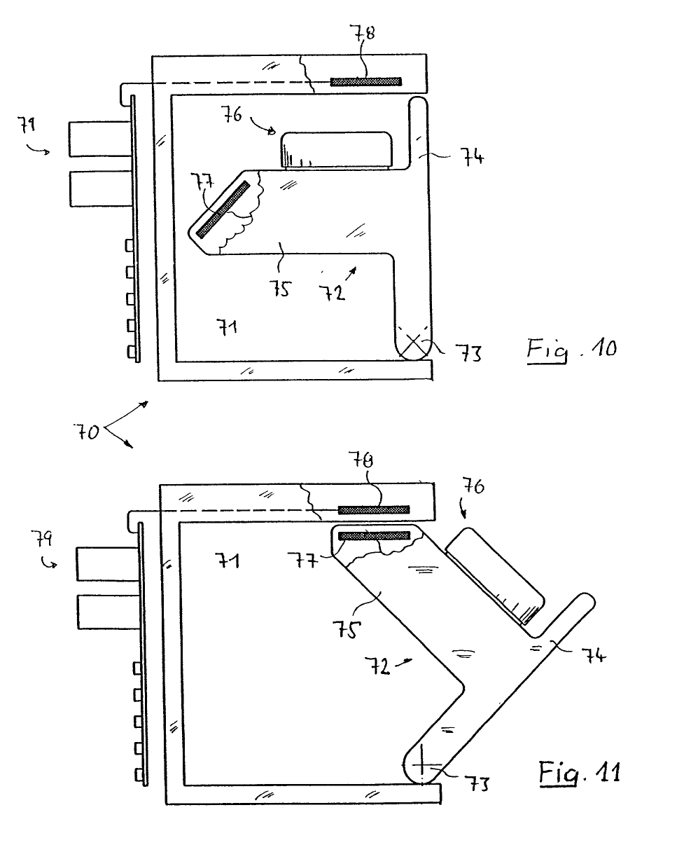

FIG. 9 A diagrammatic vertical section through another embodiment of a docking device with a trough-shaped receptacle for an elongated operating element, which is pivotable about a horizontal axis between the rest position shown and a docking position with inclined operating elements.

FIGS. 10 & 11 A diagrammatic vertical section through an embodiment of a docking device with a fixed integrated operating part, which is pivotable between a rest position with concealed operating elements (FIG. 10) and a docking position with inclined operating elements.

### DETAILED DESCRIPTION OF PREFERRED EMBODIMENTS

FIG. 1 diagrammatically shows in plan view the top of an electrical cooking appliance 1 with a glass ceramic cooking area 2, which is surrounded by a narrow frame 3 and built into a substantially rectangular recess of a wooden work plate 4.elow the glass ceramic plate 2 are located electrical operating devices in the form of radiant heaters heating the individual cooking zones 5 of the electrical cooking appliance. The e.g. four cooking zones of different sizes and/or shapes are all located within the rectangular working area of the electrical cooking appliance, surrounded by the frame 3 and defined by the glass ceramic plate 2.

In the interior of the hob below the glass ceramic plate 2 is housed a power unit 8, diagrammatically shown in FIG. 2 and which is so adapted to the heating devices associated with the cooking zones that it is able to supply electric power to one or more or all the heating devices. The power unit can be embodied on a plate in the form of a closed subassembly (cf. FIG. 10). The power unit, which can also be called a power circuit, forms a functional component of the control provided for the electrical appliance. The design of the power part is adapted to the nature and/or number of electrical functional devices of the electrical appliance to be controlled.

One special point is that the operating and functional scope of the electrical appliance is substantially completely embodied in a control unit 9 separate from the power unit and which is associated with a separate operating unit 10 for operating the control. The elements of the control unit 9 housed within the operating unit casing substantially embody the entire regulating and control part of the control. The operating unit can have at least one processing device for a preferably digital processing of data, particularly with at least one microprocessor. This processing device can essentially form the entire control and regulating part for the electrical appliance. The control unit or operating part can also have at least one data storage means, in which can e.g. be stored different program sequences for the control and/or parameters of evaluating functions of the electrical appliance. Such parameters of evaluating functions can e.g. be established and stored on installing the electrical appliance. It is also possible to store seriesspecific data of the electrical appliance. Preferably the store or memory is placed in the control unit or directly associated with the processing device. Thus, essentially the entire “intelligence” of the electrical appliance can be housed in the operating part. In the example the operating part, optionally with the exception of a battery having a low capacitance for ensuring the saving of the memory content of the microprocessor, has no electrical power supply, so that there is no need for casing space for housing a battery.

In the embodiment shown the operating unit is constructed as a removable and replaceable operating module separated from the electrical appliance. The compact operating part constructed in a flat or shallow manner in much the same way as a remote control or remote has several input devices for the manual operation of the control. The input devices comprise several operating elements 11 in the form of push buttons, sliders or knobs accessible from the top of the operating unit. On the top of the operating unit there are also four electrical display devices 12 in the form of circular LCD displays, which can optically transmit in simple manner by means of a circular twelve segment display readily comprehensible information concerning the operating state of the electrical appliance or the control. In the embodiment shown the display devices 12 are spatially separated from the associated operating elements 11, but are unmistakably related with the associated operating elements and also the cooking zones 5 controlled by them.

For putting the control into operation it is on the one hand necessary to supply the control unit 9 housed in the operating part 10 with the electric power necessary for its operation and on the other there must be a signal exchange necessary for the control between the control unit and the operating unit and also the power unit 8. For this purpose a docking device 15 is provided, which is positioned immediately adjacent to a lateral edge of the glass ceramic plate 2 in the hob frame 3 and in the represented embodiment is in the form of a separate docking unit, which is manufactured separately from the electrical appliance and which can be purchased optionally separately therefrom and which as regards shape and/or design can be so adapted to the electrical appliance that it can be attractively inserted in an already provided gap in the frame 3, or such a gap which has been sawn out. The docking unit 15 has a flat or shallow plastic housing 17, whose height is less than twice the thickness of the ceramic plate 2. On the casing longitudinal side facing the glass ceramic plate is formed a steplike receptacle 18 in which, during the insertion of the docking device, the edge of the glass ceramic plate 2 can be introduced in such a way that the housing 17 engages below the said plate 2 in the vicinity of the receptacle and the planar top of the glass ceramic plate 2 is substantially flush with the planar top 19 of the docking unit 15. The underside of the flat docking unit parallel to the top 19 then rests flat on the top of the work plate 4. All the electrically active components of the docking device are placed on a common printed circuit board 21, which is placed in the downwardly open interior of the housing 17 and is held and sealed in moisture-tight manner in position by a moisture-tight pouring compound 22. The associated electric lines 23 are passed from the casing side facing the electrical appliance out of the docking device 15, through an opening on the side wall of the hob to the power unit 8. For the moisture-tight sealing of the interior of the docking device and the transition area with respect to the electrical appliance, on the outer edge of the casing 17, namely on the underside of the latter is provided a circumferential seal 23 for pressing on the work plate top.

The electrical components of the docking device comprise two transmitting coils 25, connected to an a.c. voltage source of the power unit 18, for supplying the electrical components of the operating unit 10 with electric power. The corresponding receiving coils 26 are so housed in the casing of the operating module 10 that they are essentially only in the active area of the transmitting coils 25 in the docking position of the operating module 10 shown in continuous line form in FIG. 1 and in broken line form in FIG. 2. This ensures that all the electrical components of the operating unit connected to the receiving coils 26 are only operative when the operating unit is in the docking position shown. Even a slight raising and/or shifting of the operating unit 10 from this position leads to an interruption of the active or working connection between the coils 25, 26 and therefore eliminates the control-effective connection between the control and power units, which is particularly advantageous for operational safety reasons.

For the provision of a signal-transmitting connection between the control unit 9 and power unit 8, in the system shown there is a signal transmission means 28 operating in wireless manner by means of infrared light, which functions bidirectionally, so that it is possible to transmit in contactless manner to the control unit 9 signals from the vicinity of the electrical appliance, particularly from the power unit 8 and also signals from the control unit 9 to said power unit 8. The signal transmission means comprises on the side of the docking device 15 an infrared transceiver 29, which is positioned directly below an infrared radiation-transparent window in the upper wall of the casing 17, as well as a transceiver 31 fitted above a corresponding window to the underside of the operating unit 10 and which is associated with the control unit 9. The transceivers and/or windows are positioned in such a way that data traffic via said infrared interface is only possible when the operating part 10 is in the docking position. Alternative wireless transmission modes are possible, e.g. acoustically by means of ultrasonics or electromagnetically by means of radio.

In the embodiment shown the docking device 15 also has a magnetic field-sensitive sensor or switch 33, which is shown in exemplified manner in the form of a reed contact. Through a corresponding circuit the latter can also be used for permitting the switching on of the control only when the operating part is in the docking position. An adapted operating part can have at an appropriate location a small permanent magnet for switching the sensor 33.

For the positionally correct and in particular toolless detachable fixing of the operating unit 10 in the docking position to the docking device it is possible to provide not shown magnet holding and/or orienting means, which in the case of adequate approximation between docking device and operating element automatically bring about a correct positioning. A holding magnet of the holding means can be provided for cooperating with the magnetic field-sensitive sensor 33.

FIGS. 2 and 3 show that in the docking position permitting a control-effected connection between control unit and power unit, the operating unit is located in the immediate vicinity of, but outside the working area, namely directly alongside the glass ceramic plate 2, so that when the appliance is operating the entire glass ceramic area can be used for carrying saucepans and the like.

Further advantageous developments of the invention will now be explained relative to FIGS. 3 to 6. In the embodiment shown in plan view in FIG. 3, the docking device 35, unlike that already described relative to FIGS. 1 and 2, is not constructed as a separate part, but is instead integrated into the frame 36 surrounding the glass ceramic plate 37 of the built-in hob shown, in that a housing of the docking device 35 is constructed in one piece with the frame 36. The docking device 35 can be constructed so flat or shallow that in the case of a built-in hob it rests on the work plate surrounding the frame. However, it is also possible by means of a cutout on the work plate corresponding to the outer contour of the docking device, to flush-mount the latter in the work plate. The flat operating unit 38 is pivotably connected about a horizontal pivot pin 39 to the docking device. This permits a controlled turning or swinging round from the docking position shown in continuous line form in FIGS. 3 and 4 (with the operating elements 40 at the top) into a rest position without control-effective connection between the control and power units, the rest position on the docking device shown in FIG. 6 being defined. For this purpose the docking device has a reception depression 41 adapted to the top of the operating part in such a way that the latter can be folded in so as to ensure that the operating elements 40 are directed towards the bottom of the depression and is consequently rendered inaccessible, being covered and therefore protected by the operating unit housing. The fixed pivot pin 39 makes it particularly easy to ensure a correct positioning of the operating part in the docking position. As in the embodiment explained relative to FIGS. 1 and 2, also in this embodiment signal transmission and the power supply of the control unit of the operating part take place in wireless manner. Corresponding supply devices 42 are diagrammatically shown in FIG. 4 below the bevelled bearing surface for the operating element. There is no need in this embodiment for touch contacts for power transmission and/or signal transmission.

Although it is possible to have an optionally non-detachable, mechanical fixing of the operating part 38 to the docking device 35, e.g. in the vicinity of the pivot pin 39, in the embodiment shown there is a different and in particular advantageous holding or retention. FIG. 6 shows in section holding device 45 for the fixing in detachable manner without tools of the operating unit to the docking device using mechanical forces. The uniaxial swivel bearing for the operating unit comprises as the first bearing element after-romagnetic material bearing box 46 provided on the docking device with a cylindrically curved, concave bearing surface on its top acting in the manner of a joint socket. On the operating element 38 is formed a complimentary, second bearing element 48 with circular cylindrically curved, convex outer faces 49, which cooperate with the joint socket 47 for forming a uniaxial swivel joint. For the mutual fixing of the bearing elements to one another a permanent magnet 50 located within the cylinder is provided for each joint socket-joint cylinder pair and which in conjunction with the ferromagnet 46 brings about a magnetic attraction between the bearing elements. This substantially exclusively magnetic holding makes it possible for the easy removal from the docking device 35 of the operating element 38, e.g. for cleaning purposes and an equally easy refitting thereto.

The operating unit 38 has two operating elements 40 in the form of knobs, as well as display devices 52 in the form of circular liquid crystal displays (LCDs), integrated into the associated knobs. Through the integration of the display means into the associated operating element, there is a particularly clear and unmistakable association between the operation of the operating element performed by the user and the change on the electrical appliance resulting therefrom. The safety of operation is further assisted by the fact that the twelve segment display, as a result of the analogy to a time display on a clock, gives the user a particularly good idea concerning the order of magnitude of the set and displayed parameters.

FIG. 7 diagrammatically illustrates in exemplified manner another embodiment of the invention, in which an operating unit 55 on a docking device 56, constructed as a separate docking unit, is so linearly movably guided that the transition between the left-hand docking position and the right-hand rest position is brought about by lateral displacement of the pperating unit. It is clear to see that in the left-hand docking position, as with the embodiment of FIG. 1, the operating element is positioned immediately adjacent to but outside the working area defined by the glass ceramic plate 57. However, in the right-hand rest position the operating element projects into the working area, so that at a first glance it is clear to the user that it is not possible to operate the control in this state. As in the other embodiments the operating unit 55 is removable from and connectable to the docking device in wireless manner for signal and power transmission.

FIG. 8 shows another possibility for a controlled adjustment of an operating unit 60 between the docking and rest positions. The docking device 61 constructed as a docking unit integratable into the hob frame forms a sectionally circularly defined side attachment to the hob and is adapted as regards shape to the circular disk shape of the operating part. This is brought about by rotation about a vertical rotation axis (perpendicular to the paper plane) between the rest and docking positions.

FIG. 9 shows another embodiment of a docking device 65 with a trough-shaped, cross-sectionally semicircular, elongated erception depression 66 for an operating unit 67, which has a narrow, elongated shape and can have several, e.g. four combined display and operating elements 68 arranged in a row. In the rest position shown with vertical rotation axis of the operating element 68, the symbolically represented transmission means 69 for signals and/or for electric power are so staggered that the operating part is inoperative. For putting into operation the operating part, guided through the trough-shaped receptacle, is pivoted about its horizontal longitudinal axis until the elements of the transmission means 69 are in active connection with one another. This operating element 67 can also be removed from the depression. As a result of the depression construction there is a possibility of not having separate holding means, such as the aforementioned magnetic holding means, because the depression ensures a correct positioning of the operating element except for the rotary position about the horizontal pivot pin.

FIGS. 10 and 11 shows another embodiment of the invention in which the docking device 70 forms a reception space 71, bounded in rectangular manner and which receives the operating part 72. In the vicinity of a pivot pin 73, the operating part here is non-detachably connected to the docking device and can be pivoted by means of the pivot pin between the rest position shown in FIG. 10 and the docking position shown in FIG. 11. The approximately T-shaped operating part 72 in the vertical section shown has a wall section 74 connected to the pivot pin 73 and which closes the reception space in the rest position (FIG. 10) in the manner of a lid, as well as a functioning section 75 on whose top are located the combined operating/display units 76. In the vicinity of the free end of the funtional section projecting into the reception space are located the devices 77 associated with the operating element for the wireless transmission of information signals and electric power. The corresponding devices 78 associated with the docking device are located in the upper wall of the reception space 71 and are connected to the power unit 79.

In the rest position the operating elements of the operating unit are housed in the inner space 71 of the docking device protected against access, dirt and the like and with respect to its electrical function the operating unit is out of operation, because the transmission means 77, 78 are not in active connection with one another. For putting the control into operation the operating unit is swung outwards by means of the swivel joint 73 into the docking position, where the transmission means 77, 78 are in active connection with one another, so that the control unit located in the operating unti is control-effectively connected to the power unit 79. In this operating element position the operating elements can easily be operated from an upwardly sloping arrangement and the integrated display elements can be easily read. It is clear that despite a fixed pin 73, the entire communication between the power unit 79 and control unit takes place in contactless or wireless manner, so that there is no need for cables and/or sliding contacts, etc. The docking device 65 can e.g. be placed on the front of the electrical appliance to be operated, e.g. slightly below the working surface of the appliance defined by a glass ceramic plate.

1. Control for controlling an electrical appliance, the electrical appliance comprising a working area and at least one electrical operating device associated with the working area, the control comprising:
at least one power unit for supplying electric power to the operating device;
at least one control unit for controlling the power unit; the control unit being associated with a seperate operating unit for operating the control; and
at least one docking device for coupling the control unit to the power unit in a control-effective manner;
wherein the docking device is constructed in such a way that the operating unit is located in a docking position outside the working area.

2. Control according to claim 1, wherein the docking device and the operating unit are adapted to each other in such a way that a control-effective connection between the control unit and the power unit is only possible if the operating unit is in the docking position.

3. Control according to claim 1, wherein the docking device is provided on a docking unit, the docking unit being seperate from the electrical appliance and being adapted to be fitted to the electrical appliance outside of the working area of the electrical appliance.

4. Control according to claim 3, wherein the working area of the electrical appliance is surrounded by a frame and wherein the docking unit is at least one of adapted to be integrated into the area of the frame and integrated into the frame.

5. Control according to claim 1, wherein the electrical appliance is an electrical cooking appliance comprising a glass ceramic working surface forming the working area of the electrical appliance.

6. Control according to claim 5, wherein the glass ceramic working surface is surrounded by a marginal area and wherein the docking device is one of fitted and fittable in the marginal area adjacent to the glass ceramic working surface outside the glass ceramic working surface.

7. Control according to claim 1, wherein the operating unit and the docking device are constructed such that the operating unit is detachably coupled to the docking device.

8. Control according to claim 1, wherein a mounting device is associated with the electrical appliance and wherein the mounting device is adapted for mounting the operating unit on the docking device in a movable manner, the mounting device being constructed such that the operating unit, accompanied by the mounting device, is movable between a rest position and a docking position.

9. Control according to claim 8, wherein the mounting device is constructed such that the operating unit can be uniaxially pivoted between the rest position and the docking position.

10. Control according to claim 8, wherein the mounting device comprises at least one first bearing element associated with the docking device and at least one second bearing element associated with the operating unit and complementary to the first bearing element, and further comprises magnet means for fixing the bearing elements to each other using magnetic forces.

11. Control according to claim 1, wherein a holding device is provided for fixing the operating unit to the docking device in such a way that the operating unit and the docking device are detachable without using tools, the holding device operating by magnetic holding means.

12. Control according to claim 1, wherein the operating unit is free of an own power supply for powering the control function of the control unit.

13. Control according to claim 1, wherein the power supply device for supplying the control unit with electrical power is associated with the operating unit and wherein the power supply device is constructed such that the control unit can only be supplied with electric power when the operating unit is in a docking position.

14. Control according to claim 1, wherein there is provided a power supply device for the operating unit and wherein the operating unit and the power supply device are detachably connectable.

15. Control according to claim 1, wherein there is provided a power supply device for supplying the control unit with electric power, the power supply device comprising inductive power transmission means including at least one receiving coil associated with the operating device and at least one transmitting coil associated with the area of the docking device.

16. Control according to claim 1, comprising signal transmission means for wireless transmission of control signals between the control unit and the power unit.

17. Control according to claim 16, wherein the signal transmission means are at least one of adapted for operation with infrared radiation and adapted for operating bidirectionally.

18. Control according to claim 1, comprising a signal transmission means for transmitting control signals between the control unit and the power unit, wherein the signal transmission means are constructed such that the control signals can only be transmitted if the operating unit is in the docking position.

19. Control according to claim 1, wherein the operating unit includes at least one display device for displaying at least one operating parameter characterizing at least one of the operating state of the control and the operating state of the electrical appliance.

20. Control according to claim 1, wherein the operating unit comprises at least one operating element for setting at least one control parameter and wherein an electrical display device is integrated in the operating unit for displaying at least one of the control parameter set by the operating element and an operating parameter influencable on the basis of the control parameter.

21. Control according to claim 19, wherein the display device comprises at least one of at least one liquid crystal display and a substantially circular display device comprising twelve display elements arranged in a clock-like manner.

22. Control according to claim 1, wherein the control unit comprises at least one processing device for the processing of data and at least one data storage means for storing control-relevant data, such as different program sequences or control parameters.

23. Control according to claim 22, wherein the processing device is adapted for digital processing of data and includes at least one microprocessor.

24. Docking unit adapted for arranging an operating unit of a control of an electrical appliance in a docking position, the docking unit being constructed for integration with the electrical appliance, wherein:
the operating unit contains a control unit of the control;
the electrical appliance contains a power unit of the control;
the control unit and the power unit are control-effectively connected when the operating unit is in the docking position.

25. Docking unit according to claim 24, wherein the electrical appliance is a electrical cooking appliance comprising a glass ceramic cooking area and wherein the docking unit is constructed for integration into a frame surrounding the glass ceramic cooking area.

26. Electrical appliance comprising an electrical operating device and at least one power unit for controlling the power of the operating device, wherein the electrical appliance is substantially free from at least one of operating elements for operating the operating device and a control unit for controlling the power unit.

27. Electrical appliance according to claim 26, wherein the electrical appliance comprises a docking unit, the docking unit being adapted for arranging an operating unit of a control of the electrical appliance in a docking position, wherein:
the operating unit contains a control unit of the control;
the electrical appliance contains a power unit of the control;
the control unit and the power unit are control-effectively connected when the operating unit is in the docking position.

28. Electrical appliance according to claim 26, wherein the electrical appliance is prepared for fitting of a docking unit to the electrical appliance, the docking unit being adapted for arranging an operating unit of a control of the electrical appliance in a docking position, wherein:
the operating unit contains a control unit of the control;
the electrical appliance contains a power unit of the control;
the control unit and the power unit are control-effectively connected when the operating unit is in the docking position.

29. Electrical appliance according to claim 26, wherein the electrical appliance is an electrical cooking appliance with a glass ceramic cooking area.

30. Operating unit for operating an electrical appliance, the operating unit comprising:
a control unit constructed for operating with a power unit, the power unit being provided on the electrical appliance;
the operating unit being constructed in such a way as to be fittable to a docking device associated with the electrical appliance in a docking position, wherein in the docking position the operating unit is located outside a working area of the electrical appliance and the control unit of the operating unit is coupled in control-effective manner to the power unit.
